(19) United States
(12) Patent Application Publication
(10) Pub. No.: US 2014/0218482 A1
(43) Pub. Date: Aug. 7, 2014

(54) Positive Train Control Using Autonomous Systems

(71) Applicant: John H. Prince, Los Altos, CA (US)

(72) Inventor: John H. Prince, Los Altos, CA (US)

(21) Appl. No.: 13/759,390

(22) Filed: Feb. 5, 2013

(51) Int. Cl. H04N 7/18; B60Q 1/00

(52) U.S. Cl. CPC H04N 7/181; B60Q 1/0023
USPC 348/47; 382/103; 348/118

(57) ABSTRACT

The use of widely separated and coordinated cameras allows trains to recognize obstructions and calculate distance to them to a degree which enables them to react quickly and brake early enough to avoid accidents. This applies to hazards such as fallen trees, stalled cars, people, and other trains on the rails. The system can also apply to crossings, enabling them to see approaching trains and gauge their distance, velocity, and deceleration, so that they can be shut down early and alarms sounded immediately. These systems are autonomous, using software which allows trains to know exactly where they are and at what speed they are travelling independently of external signals, including GPS, allowing a measure of safety beyond normal communications. These systems can also work in the infra-red, allowing compensation for fog and rain.

### BACKGROUND OF THE INVENTION

1. Field of the Invention

The Rail Safety Improvement Act of 2008 (RSIA) mandated that Positive Train Control (“PTC”) would be implemented across a significant portion of North American railroads by Dec. 31, 2015. PTC refers to train control technology which is based on continuous communication-based or processor-based train control technology that provides a system capable of reliably and functionally preventing train-to-train collisions, over-speed derailments, incursions into established work zone limits, and the movement of a train improperly through a main line switch. PTC systems are required, as applicable, to perform in all weather.

Because of the oft-stated (and often demonstrated) unreliability of many of the existing and possibly conflicting signaling and control technologies, the present invention includes autonomous means by which moving trains can avoid hazards.

By sharpening reaction times (through autonomous means) beyond what a human can normally do, the human factor as a cause for most accidents can be reduced or eliminated.

The field of the invention includes means by which a moving train knows exactly where it is at all times, how fast it is travelling, on which tracks and in which direction, irrespective of external signals.

A moving train may be aided in this by comparing prior knowledge with present information from its own independent active sensors.

This invention also includes secondary safety means in which work zones, level crossings, railway stations and other areas of actual or potential human traffic can be made aware of the speed, acceleration or deceleration, and expected arrival of moving trains uniquely and independently of all other forms of communication. That is to say, these systems will also be autonomous and able to react positively and instantaneously to new information.

2. Description of the Related Art

We will briefly describe the oldest and most widely used form of train control—block signaling. The related art is well described in AREMA, and a synopsis is given in Wikipedia.

To put it generally, trains run in blocks. Most blocks are “fixed”, in that they include a section of track between two fixed points. Blocks are designed to allow trains to operate as frequently as possible. On lightly used lines a block may be many miles long. For a busy commuter line the length may be a few hundred yards. No train is permitted to enter a block until a signal indicates that the train may proceed, or a dispatcher or signalman instructs the driver accordingly, or the driver takes possession of the appropriate token. In most cases, a train cannot enter the block until the block itself clear of trains, plus there is enough space beyond the block's end for a train to stop. In systems with closely spaced signals, this overlap could be as far as the signal at the end of the following section, in effect ensuring a space of two blocks between trains.

A disadvantage of fixed blocks is that faster trains require longer to stop, so blocks need to extend further, decreasing a line's capacity. Under a new “moving block” system, computers calculate “safe zones” around moving trains, into which other trains are not allowed to enter. These systems depend on knowledge of the precise location and speed and direction of each train, which are determined by a combination of sensors: active and passive markers along the track and train-borne tachometers and speedometers. (GPS systems cannot be used because they do not work in tunnels). With a moving block system line-side signals are unnecessary, and instructions are passed directly to the trains. This creates the advantage of increased track capacity by allowing trains to run closer together while maintaining required safety margins. Moving blocks are in use on Vancouver's Skytrain, London's Docklands Light Railway, New York City's BMT Canarsie Line, and London's Jubilee Line. This technology was also intended to modernize Britain's West Coast Main Line, allowing trains to run at higher maximum speeds (140 mph or 230 km/h), but the technology was deemed immature because of the variety of traffic, such as freight and local trains as well as expresses, to be accommodated on the line, and the plan was dropped. It now forms part of the European Rail Traffic Management System's level-3 specification for future installation in the European Train Control System, which will (at level 3) feature moving blocks that allow trains to follow each other at exact braking distances.

The size of the blocks and the spacing between signals is calculated (for example) by accounting for the maximum reasonable speed for particular types of train; the track gradient (to compensate for longer or shorter braking distances); the braking characteristics of trains with different inertias (such as freight or fast passenger trains); sighting (how far ahead drivers can see signals); and a driver's reaction time.

For us two salient features are a driver's “sighting” distance and his reaction time. Our objective in the present invention is to give a driver not only an extra set of eyes, but a mechanism with the ability to react instantly and autonomously to perceived dangers.

Within our system we depend on the train itself knowing its precise location, speed and direction based on instant recognition of track features, as will be described.

Our system also differs in that all the computers necessary will already be onboard the trains, enabling each individual train to make decisions on its own, rapidly and effectively, not relying on any outside source.

The description of related art also includes the sensing of trains travelling towards level crossings and work areas. So far this has depended on the ability of signal-blocks adjacent to these areas knowing that a train is arriving, usually by rail impedance. This process, activating a “relay armature drop” lowers barriers and flashes warning signs (normally) for 20 seconds ahead of transit.

On crossings equipped with such motion detectors, the crossing warnings activate when a train approaches a certain point on an approach block. This is the moment when the train's axles shunt enough current from the battery supply to cause the relay's coils to fail to sustain an armature. This causes the armature to drop, and in doing so the crossing warning light switch is flipped from green to red, and the barriers are let down.

The rate of current drop also depends linearly on the speed of a train. From this, one can calculate the speed of a train and its acceleration or deceleration. One can even undo the crossing operation if the train stops or reverses.

As the train leaves the crossing area, the shunting effect of the train's axles diminishes, the relay current increases, and the coils pick up the armature, turning the lights to green and lifting the barriers.

The accuracy of this system depends on the state of the tracks, particularly on the “ballast resistance”—the ability of the ballast to shunt some of the electric current from its normal circuits. When good ties are supported on good crushed rock and the entire section is dry, the ballast resistance is at a maximum, and the system works best. When the ties are old, on wet ground and covered in debris, the ballast resistance is at a minimum, and the system is degraded. The weather also plays a role in affecting the offsets and sensitivity of the crossing control circuits.

This system (in one version) is shown in FIG. 10. It will be briefly described later in relation the present invention.

There are 140,000 miles of standard-gauge mainline track in North America with over 25,000 railroad crossings, plus many urban and commuter lines with more closely spaced crossings. All could benefit from pairs of coordinated eyes with sufficient acuity to sense a train's approach, its distance, speed and acceleration known with much greater accuracy than heretofore, and with the ability to shut down a crossing with seconds to spare.

What is required is simple, robust, fast recognition system for trains which is autonomous and not subject to delays from a distant Central Train Control and the sometimes delayed perceptions of a train's driver. Such a system must be easily incorporated into the lead carriage or engine with simple relays to the brakes and an audible alarm, including the train's horn. Provision should be made for instantly notifying Central Train Control without being subject to them. This system should be easy to install and easily maintainable.

A similar system will also apply to crossings. A crossing system can be made completely autonomous, with the exception of a provision for notifying both Central Train Control and an approaching train if there appear to be difficulties.

In the present invention we have the opportunity to achieve these ideals. We are enabled in our endeavors by the immense recent increase in computing power, storage capacity and communication ability in electronics, easing our tasks of assembling the 3D components and contributing the algorithms to make the system feasible. And all this can be done at a reasonable cost and deployed in a reasonable time, in accordance with the PTC mandate, by Dec. 31, 2015.

### SUMMARY OF THE INVENTION

The present invention encompasses the field of safety in collisions between trains on the tracks and with people at intersections. In all cases we use the ability of 3D systems to recognize objects at a distance and to calculate distance, velocity (and change of velocity) better, clearer and faster than a pair of human eyes and more accurately than existing technology. The extra seconds can make all the difference between a potential collision (from which people walk away with a few seconds to spare) and a terrible accident.

By analogy with a pair of eyes, our illustrations show how cameras separated by 8′ at the front of a train can (given good cameras) have the same visual acuity at a distance of 1000′ as a pair of human eyes at 25′. We take advantage of this separation, along with the processing speed of our computers, for a train with such cameras to distinguish (at 1000′ or even 3000′) between cows, trucks and humans at or near the tracks, and also compute their vector potential for crossing the tracks at the same time as the train.

It is more difficult and even more essential to prevent head-on collisions between trains travelling at 60 mph in opposite directions. As described below, the trains should know to the inch where they are on the tracks, how fast and in which direction they are travelling, from continuously recognizing details in previously recorded images. But for controller (or even driver) error they should not be travelling in the same block and in opposing directions. But if they are, recognizing each other and slamming on the brakes will minimize an impact, and perhaps allow the engineers to escape unharmed.

In the case of freight trains with mile-long loads special attention must be given to maximizing the acuity of the cameras to give them long distance accuracy.

The mathematics of vision becomes even more compelling at level crossings, where cameras can be mounted across the tracks at 50′ and can measure depth as accurately at 3000′ as a pair of human eyes at 12′. The mountings can also be made more stable than on a moving train, thus avoiding the necessity for algorithms to stabilize the images, and therefore allow them to calculate more quickly the potential for impact.

Calculations become simpler and faster also if the cameras are closely matched, just as with our eyes. A synopsis of the alignment procedure (described in other patents of this writer) is given below.

In all cases, the emphasis is on speed of calculation, so that if anomalies are discerned, the train can slam on its brakes, or the intersection can be shut down and alarms sounded, well before any possibility of collision.

We note that an occasional false alarm (which may be susceptible to improved programming) will always be preferred to a horrific accident.

Visual recordings of a track made previously in great detail, such as are those made in 3D for the purposes of analysis (a subject of this writer's prior submission), show that every section of track, including every tie and every rail, whatever the material, be it concrete, Douglas fir, steel or plastic, have individually or in combination, characteristics which are as distinguishable as fingerprints, so that they can be recognized again. With proper track recognition the train's location can be established within an inch.

The train's journey will be very much like we ourselves walking down a well-known road—so long as it is done frequently, the features will be there very much as they were before, and time and weather will have not excessively degraded those impressions. It is better to get updates regularly, and even better if all trains are equipped with the necessary “black box” cameras.

In general with GPS and other clues (including its planned itinerary) a train will know where it is within a certain distance, on which track, and in which direction it's travelling. So that the knowledge database can be limited to a certain small subset of all the information available for the entire system, possibly within a block, and certainly within a few miles.

With a recognition system for knowing its position and velocity, and a pair of sharp camera eyes for perceiving problems ahead, a train and its engineer will be well-equipped to handle difficulties instantaneously at 1000′ (and frequently at 3000′ or more) down the tracks. This would come far towards satisfying the PTC requirements.

In all cases, the emphasis is on speed of calculation, so that if anomalies are discerned, the train can set its brakes, or the intersection can be shut down and alarms sounded, well before the possibility of a collision.

### BRIEF DESCRIPTION OF THE DRAWINGS

This invention, with its further advantages described below, may be understood best by relating the descriptions to the appended drawings, where like reference numerals identify like elements, and in which:

The words “cameras” and “detectors” are used interchangeably since they refer either to the same object or the active part of it. This simplifies our discussion below. The words “intersection”, “level crossing” and “train crossing” all refer to the same object 11 in the drawings. The phrase “three-dimensional” is abbreviated to “3D”.

On its left-hand side, FIG. 1 shows a picture of a train 10 approaching a level crossing 11, with a pair of detectors 1 and 2 (inside sealed cameras) which are mounted at the extremities of the width of the engine, preferably near the level of the driver. This picture could just as easily show a train approaching items on or near the tracks such as fallen trees, a stalled truck, or another train.

FIG. 2 is a diagram showing how a pair of cameras 1 and 2 compare with a pair of human eyes 41 and 42 in terms of seeing an object at a distance. We will cover this more later.

FIG. 3 shows a diagram for computing the distance and the approach velocity of the train 10 to the crossing 11, and to any objects which may be on or crossing the intersection at the same time. The crossing (or objects) will appear to move from 13 to 18 then to 20 in sequence from detectors 1 and 2, which will instantly give the velocity (and if necessary, deceleration) of the train.

FIG. 4 (with certain assumptions) shows a plot of the parameters of distance, velocity and acceleration, along with their accuracy, as the train approaches the crossing.

FIG. 5 shows a classical pinhole model of the two detectors (and cameras) which enable the use of vector algebra to calculate the parameters of an object p with respect to the train 10. In this case the calculations are simplified since objects will (in general) lie on a single plane 30 defined by the pinholes c₁ and c₂ of the train's two cameras and the object p.

FIG. 6 shows a hyperbolic curve deriving from calculations from FIG. 4. This shows that at 1000 meters (3,280 feet) the train has a good resolution of distant objects, but that as the train gets closer the resolution dramatically. These numbers are plotted on FIG. 7.

FIG. 8 shows the velocity, deceleration and stopping distance of a train slowing from 60 mph to zero with a braking force of ⅛^{th} gravity (g). This may be optimistic for long freight trains, but probably underestimates the braking power of commuter or subway trains.

FIG. 9 is a diagram of prior art, based on the changing resistance of a section of track as a train approaches an intersection. It can also be used to calculate an approaching train's velocity.

FIG. 10 is used to compare the resolution of a matched pair of cameras at a crossing or with the resolution of a resistive circuit as in FIG. 9.

For the sake of completeness, FIG. 11 shows some standard protocols for uploading 3D images from a train or a crossing to a central office.

Returning to FIG. 1, on the right-hand side are shown the crossing 11, with detectors 3 and 4 facing an oncoming train, and detectors 5 and 6 facing the tracks going away. All of these detectors will be inside their respective cameras and housings, mounted at suitable heights atop poles with the width of the tracks between.

The figures which follow lead to similar calculations as for the train, but now the cameras are separated more widely so their long-distance accuracy is greater.

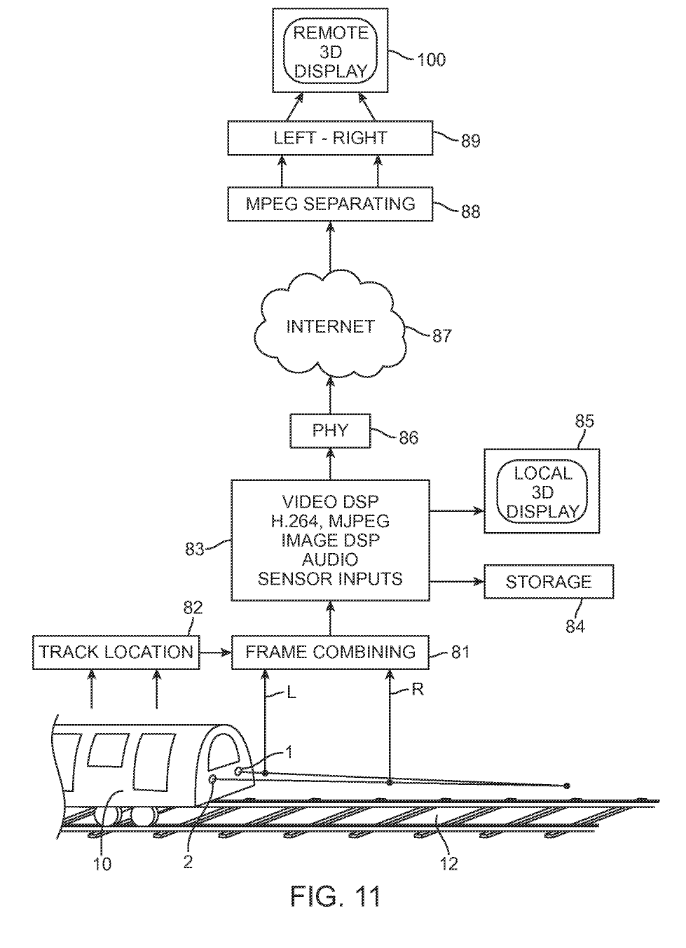

FIG. 10 shows how clearly the crossing cameras are able to resolve the parameters of distance, velocity and acceleration of an approaching train from 3,280 feet downwards.

### DETAILED DESCRIPTION OF THE INVENTION

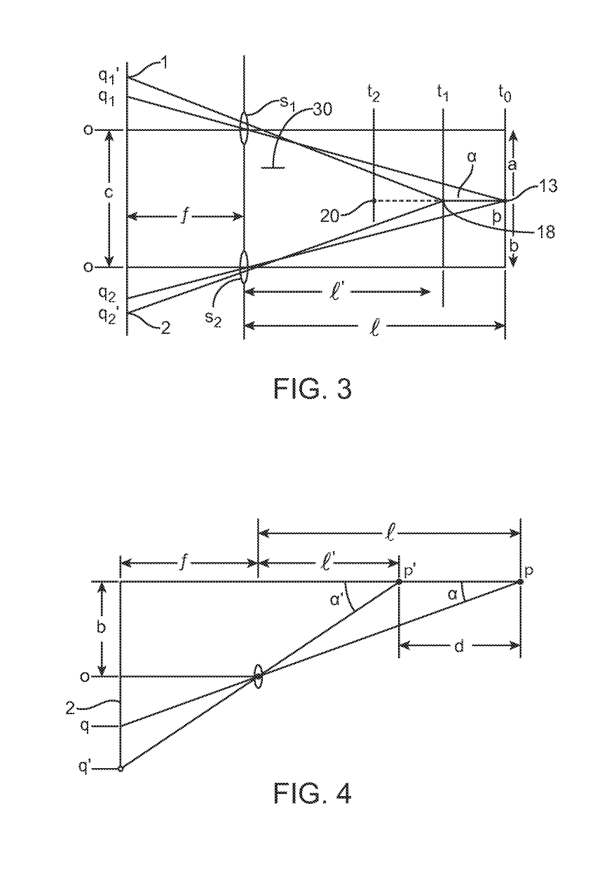

On the left side of FIG. 1 is shown a train 10 approaching a level crossing 11. A pair of matched cameras 1 and 2 separated by a distance c is mounted on the engine facing horizontally forwards towards the crossing 11. Because the train may be on a curve the components a and b of distance c (in FIG. 3) may not be equal. In this example we shall initially show a and b as equal, with the sum a +b equal to c. For utility, the cameras 1 and 2 will be mounted as far apart as possible and about level with the engine's driver (who may in future be able to see track details ahead of him on a heads-up display, which can also be in 3D)

On the right side of FIG. 1 is shown a level crossing 11 with a pair of cameras 3 and 4 facing the oncoming train 10 with another pair of cameras 5 and 6 to face opposing trains. In this example we may find a distance m of 50′ across the tracks for the separation of 3 and 4 and also 5 and 6. All of these detectors will be inside their respective cameras and housings, and mounted at a suitable height on top of poles with the width of the tracks between. Here we have the benefit of width (enabling the cameras to compute velocity and depth further) and stability (to minimize the necessity of vibration stabilization).

For purposes of measuring distance, velocity and acceleration, in our example here the systems of both crossing and train will be self actuated, or autonomous. The systems may set off alarms autonomously (without external inputs) if certain programmed thresholds are exceeded. In the case of trains, brakes may be automatically applied in case of perceived conflicts on the tracks. Autonomous, fast-reacting systems are designed to avoid failure from erratic or failure-prone inputs, such as from GPS signals or delayed human responses.

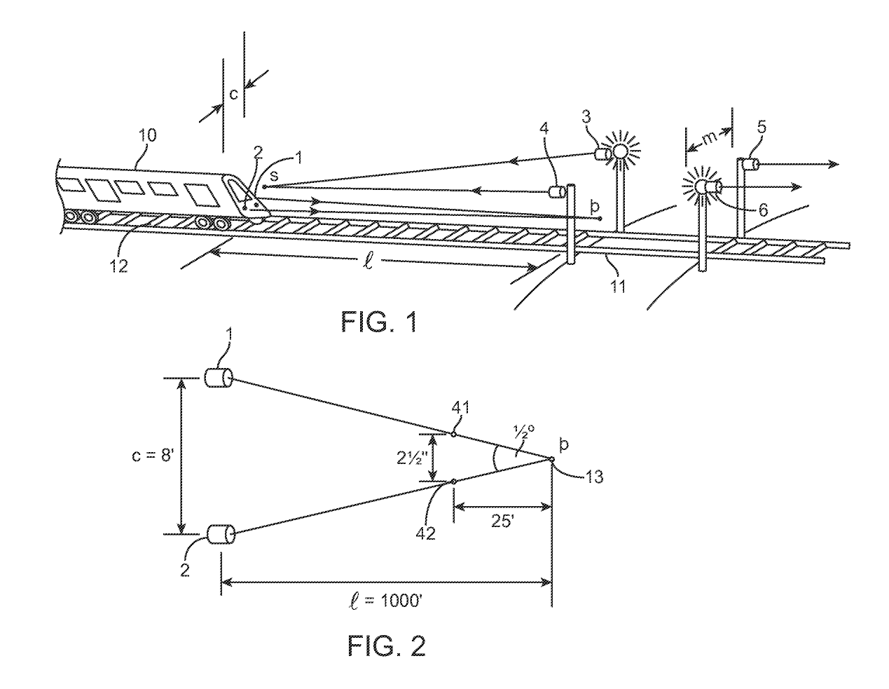

By analogy with a pair of eyes, FIG. 2 shows how the cameras at a separation 1 and 2 of 8′ have the same visual acuity of an object 13 at a distance of 1000′ as do a pair of human eyes 41 and 42 at 25′. We take advantage of this separation, along with the processing speed of our computer chips, to distinguish (at anywhere up to 3000′) between cows, trucks and humans at or near the tracks, and also to compute, in the case of humans, their velocity and potential to be crossing the tracks at the same time as the train.

In FIG. 3 we show (in this example) all calculations for the train and (later) the crossing as symmetrical and lying on a single plane. This will be the plane 30 stretching approximately horizontally in front of the cameras 1 and 2 of the train and including point 13 (denoted asp). This plane 30 is called the epipolar plane and used here to show the timing, distance, velocity and acceleration of either an object crossing the train's path or that of the train itself approaching the crossing.

FIG. 3 shows a diagram for computing the distance and the approach velocity of the train 10 to the crossing 11, and to any objects which may be on or crossing the intersection at the predicted crossing time. The train will identify its own position and know its distance from the intersection by “reading the tracks”—a program created by this writer and (hopefully) previously installed by the operator, which will also give the train its velocity. If not, these parameters will be computed through the optical means of the present invention.

FIG. 4 now shows a greatly simplified version of FIG. 3 for the purposes of the following calculation. For an approaching train looking a singular, distant point on the crossing as point p this will subtend an angle α from the normal on detector 2, then (dropping the subscript for q)

tan α=q/f=b/l

Where b is the distance of point p from the centerline of camera 2, f is the focal length, l is the distance of the train from point p, and q is the distance of the image of point p from the centerline between detectors 1 and 2.

As the train 10 approaches the crossing 11, the point p (at 13) will appear to move to point p¹ (at 18), and the angle a will change to α¹, then

tan α¹=q¹/f=b/l¹

Since the focal length f of the cameras and their geometry a+b is constant, then

bf=k

and d=l−l¹=k/q−k/q¹=k(q¹−q)/q¹q

In FIG. 6 this gives us a hyperbolic curve showing a simple means of visualizing the relationship between the distance l of the train to the crossing and the pixel offset in the detectors q.

FIG. 7 shows the results of this curve for the train. When the train is at 3,000′ it can estimate its distance to a feature on the crossing to within 46′—i.e. to within 1.5%. As it nears to 1000′ feet this estimate is 5′, or 0.5%. The train's computers meanwhile have been calculating whether the object is a hazard, whether it's moving, whether collision avoidance is necessary, and as will be shown, at this distance it may be the last moment possible. Therefore the accurate knowledge of this distance is critical.

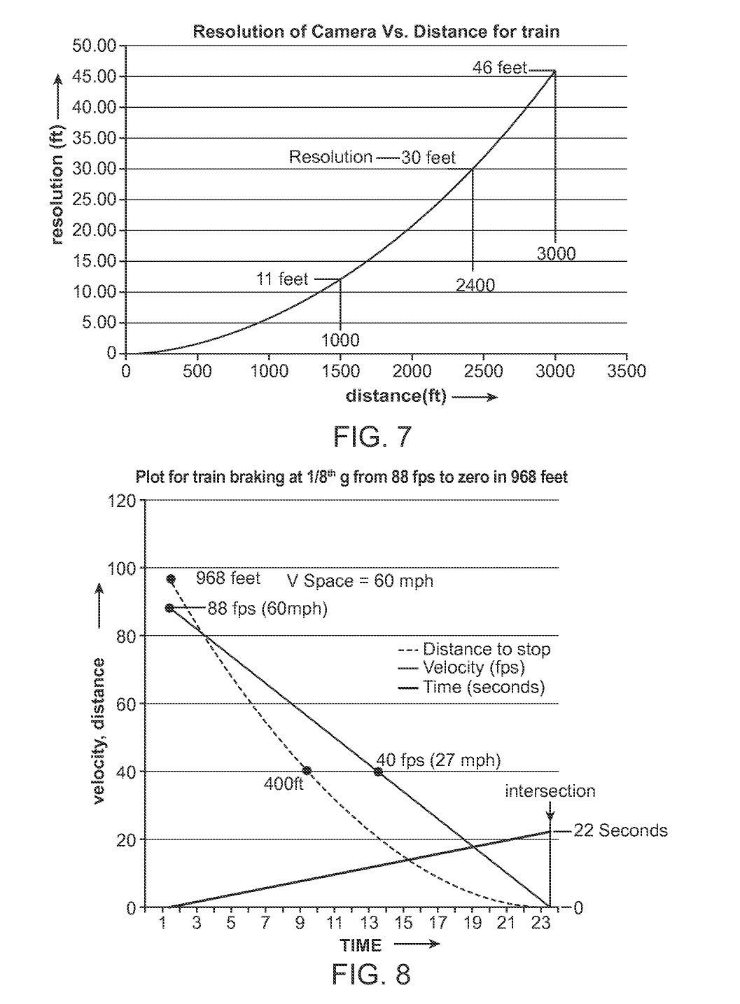

Derived from simple calculation, FIG. 8 shows that with a braking force of ⅛^{th} g a train which is travelling at 60 mph (88 feet per second) will slow down by 4 feet per second (per second) to zero in 22 seconds within a distance of 968 feet. If the tracks or intersection are blocked at this distance the train will stop just short, avoiding impact.

If the reaction time is delayed by 5 seconds (as it may well be with even an experienced operator) the train will still be continuing through the blockage at 15 mph, before stopping beyond.

The difference here is that with fast image recognition and computation this action to slam on the brakes can be taken automatically in 0.5 seconds rather than in 5.

A far greater dilemma is the action to take if two trains are going in opposite directions at 60 mph. On seeing each other at 1000′ and immediately applying the brakes an impact would happen in just 6 seconds, even if the trains are slowing down. Therefore some system of recognition at 2000′ (or more) for each train with a 0.5 second reaction time is imperative, so that the trains can stop just short of each other.

Trains are luckily large enough that they can indeed see each other at this distance, and considerably better using two well-separated 3D cameras rather than a single camera.

FIG. 7 shows the ability of a train equipped with a pair of 3D cameras to estimate position and velocity of an approaching train (assuming a fairly straight track, and in view) to a good accuracy. (If the track is not straight and the view is not clear the trains should not be travelling at 60 mph). As shown, at 3000′ the resolution for distance is 46′ and for velocity is 4′ per second. If the two trains are approaching at 60 mph, and the braking force of ⅛^{th} g is applied by both trains immediately then they will stop 1000′ short of each other. If the braking force is less and the system is not automatic, any delay of more than a few seconds will lead to collision.

The distance resolution can be improved by a factor of 50% if the cameras are mounted top to bottom on the train, separated by 12′, i.e. orthogonally to the proposed. With inexpensive cameras both sets could be mounted, achieving redundancy with greater accuracy.

It would also be possible to mount cameras at multiple angles.

This leads us to the necessity of good cameras, fast recognition and fast computation. We turn first to algorithms for camera alignment.

To create 3D images with minimum computation the cameras should be created as matched pairs. Most conveniently they will use identical detectors and have identical optics.

For camera pairs we can enumerate certain physical degrees of freedom—focal length, aperture, zoom, x, y and z, and pitch, roll and yaw. All degrees of freedom must then be adjusted together so that cameras in pairs match each other as closely as possible. As examples, the pose of the cameras, i.e. their axes, should intersect; apertures also should be adjusted to give matching light intensity on the detectors, etc.

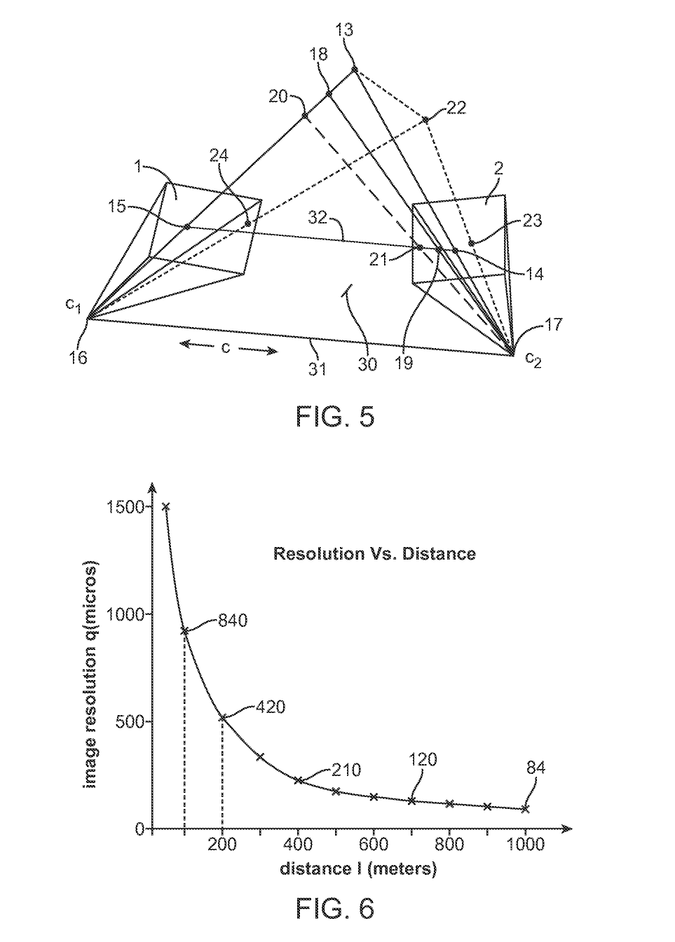

A first step is primary alignment. The cameras' primary function is to recognize and accurately calculate distances to objects far away. Ideally they should be adjusted towards infinity, which is to say with their poses parallel to each other and to the ground. This would describe the epipolar plane 30 as in FIG. 3 and in FIG. 5 with point p at infinity. In practice this could be an object such as a signal post at the same height as the cameras, several hundred feet along the tracks. The two images may be brought (visually, through manual adjustment) into close correspondence in all their degrees of freedom onto a 3D screen with overlapping images.

In the case of widely separated cameras, such as at crossings, the primary alignment can also be effected with one or both cameras using step motors to adjust their degrees of freedom. These can be actuated and monitored remotely. Step motors can also help in occasional realignment.

With proper adjustments on either the cameras or the mountings the primary alignment processes for all pairs of cameras can (typically) be done in a few minutes.

In the case of the train, because cameras 1 and 2 are close together, and it is critical for the train to sense distant objects accurately, several other steps may need to be performed.

In the first instance the cameras should be mounted on a stable, resonance-free platform, preferably as a single unit and (eventually) built into the front of the train roughly level with the lights near the driver, giving him (potentially) an extra set of eyes with a heads-up display.

This takes us into a more accurate secondary alignment using a “feature-based” approach. In general, for feature selection, any of a number of edge detection algorithms can be used, such as: J. Canny, “A Computational Approach to Edge Detection,” IEEE Transactions on Pattern Analysis and Machine Intelligence, Vol. PAMI-8, No. 6, 1986, pp. 679-698). With readily available algorithms we can pull up clear edges in milliseconds.

Choosing any one of these features, appropriately distant, we use a sum of squares function E_{SSD}(u) (See Richard Szeliski, December 2006) to look for the minimum difference between this feature as it appears on detectors 1 and 2:

E_{SSD}(u)=Σᵢ[I₁(xᵢ+u)−I₀(xᵢ)]²=Σᵢ(eᵢ)²

Where u=(u, v) is the feature displacement on the two detectors (using local coordinates) and eᵢ=I₁(xᵢ+u)−I₀(xᵢ) is the error function or feature displacement offset within the detecting areas (I₀ being the reference feature image on detector 1 and I₁ the sample image on detector 2).

This alignment of x and y coordinates will bring the two detectors 1 and 2 onto almost identical points (xᵢ,yᵢ) on their local x-y planes, differing only by their global offsets a and b on the x-axis, as in FIG. 3. This alignment applies sequentially to all camera sets 1 and 2 on the train and to sets 3 and 4, also 5 and 6 at the crossing.

Even finer sub-pixel accuracy can be achieved with gradient descent methods (as described elsewhere) but this requires better image stabilization and more computation, therefore more time, while our emphasis here is on fast reactions.

For recognition, we adopt one or more training algorithms, such as one described by C. M. Bishop in his book on Pattern Recognition and Machine Learning (2006).

For an engine 10, training will consist of running the engine over many sections of track 12 until certain patterns emerge then to use those patterns to guide the definition of anomalies. The resulting program would apply to all engines running over similar tracks

To aid in shortening response times, software may be trained using simulated (or even real-life) situations of people crossing tracks or trains meeting trains. In this we follow algorithms using histograms of oriented gradients (see Robert Szeliski, Computer Vision, pp. 611-624) in terms of picking categories, such as people or trucks or trains as being a faster way to recognize potential hazards on the tracks. First, we know that the tracks should have nothing on them at all, and second, we glean additional information from optic flow and motion discontinuities (see Efros, et al, 2003).

We return briefly to FIG. 5 This pinhole model of a train's cameras 1 and 2 show that all the points of interest to the train lie on a plane extending roughly horizontally before it, and can include intersections, fallen trees, trucks, cows and people. Because it is defined by two poles, the points c₁ and c₂, plus all the objects described previously but represented by a single object p, it is called an epipolar plane. Having all features of significance lying on a single plane simplifies our algorithms.

FIG. 5 also shows why we can do calculations with a pair of matched cameras 1 and 2 which we cannot do with a single front-mounted camera, such as exist on some trains today. Point p as seen by camera 1 may be seen approaching from positions 13, to 18, to 20 and so on. But the image position 15 does not change. Therefore a single camera looking head-on cannot calculate velocity: it can only see a change in size. A vector such as velocity cannot be calculated with an indefinite length.

However, a second camera 2 can help define these lengths, and can help calculate position and velocity, even acceleration. As it is seen the points 13, 18 and 20 show up on detector 2 in positions 14, 19 and 21. This movement on detector 2 gives us all the information we need. All of these points, as well as the stationary point 15, lie on a singular epipolar plane 30. Within the detectors all the points 14, 19, 21 and 15 lie on a singular epipolar line 32 running through the detectors parallel to baseline 31. We can now make use of epipolar geometry in FIG. 3 and FIG. 4 to plot position and velocity as seen from both train and crossing. We have done this in FIG. 7.

In fact we can go farther. In FIG. 5 the lines from the camera center c₂ (17) intersect the line from camera center c₁ (16) at definite points 13, 18 and 20. These lines are now vectors with definite length and direction. Therefore they can be added and subtracted, giving the sections 13 to 18, 18 to 20 (and so on) definite lengths at definite times—that is, velocity. Taking the derivative of velocity over time gives us acceleration or deceleration.

On another note: a single camera cannot estimate velocity if another train's approach is sinuous—i.e. on a winding track. However, a pair of coordinated cameras using vector calculations can.

In general, as shown in FIG. 3, images of an object will show motion on both detectors. In the simplest case if these are similar we can take averages to obtain distance and velocity.

One note may accompany FIG. 5. We show an anomalous point 22 off our particular epipolar plane 30. This will generate images in positions 23 and 24 on detectors 1 and 2. Once again these images lie on a line running parallel to the baseline, but different from line 32 and on another epipolar plane. We can usually ignore anomalous images which do neither cross nor come close to our own epipolar plane 30.

For crossings 11, training is better if it is specific to location, which is to say that buildings and signs will appear permanent while moving objects will appear anomalous. Hard-edge detection algorithms will separate waving trees from moving trains. We are helped by knowing that cameras 3 and 4, also 5 and 6 need to focus with very narrow fields of view (generally up to 5°) and need (in principle) to see only down the tracks. For the most distant views this angle is just 1°.

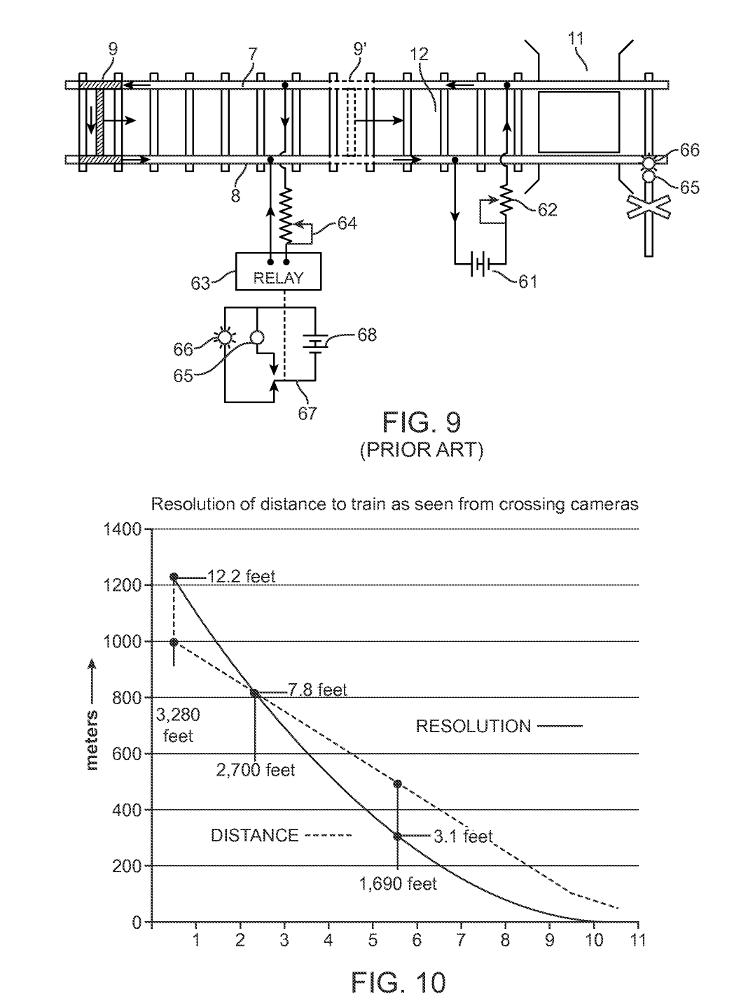

Through FIG. 9 we may describe the prior art in relation to its accuracy in predicting train crossing times. This figure shows a battery 61 with a “battery limiting resistor” 62 feeding into a section of track 12 adjacent to a crossing 11. A current from battery 61 flows through rail 7 into a relay 63 through another series (trimming) resistor 64. From here the current completes its return to battery 61 through rail 8.

As mentioned earlier the purpose of the series resistor 64 is to trim the current through the relay and remove errors caused by ballast leakage.

Ideally the relay will be set so that when a train travelling at 60 mph arrives at exactly 1,760′ from a crossing the alarms will go off and the gates will begin to descend. This will give a standard 20 seconds for motorists and pedestrians to clear the crossing.

Unfortunately, time and weather can easily upset this balance by 10% or more—on wet days a train may arrive early (by two seconds or more) and on dry days late (by several seconds). This is quite apart from errors which may occur over time from the initial setting of trimming resistor 64 (which could be significant).

An error of 10% will misplace a 60 mph train by 176 feet (two seconds) and its velocity by a similar amount.

Referring to FIG. 10 we can see that with coordinated 3D cameras at crossing 11 the resolution of a train's distance at 1,760′ is a little over 3′ (0.034 seconds)—an improvement of over fifty times that of resistance measurements. The commensurate improvement of calculations in velocity and acceleration of this train would also increase accuracy to within 0.2%.

Referring back to FIG. 7 we see that the resolution of a train's cameras, since they're closer together, is about 12′ at a distance of 1,760′—or within 0.7%. If there is a problem at the crossing—a truck is stuck—both train and crossing should be (autonomously) aware of it. However some means of automatic communication should also exist between crossing and train to let the train know that the truck may be stuck permanently.

Referring to FIG. 8 we can see that a train braking at ⅛^{th} g will need to begin applying brakes at exactly 968′ in order to stop dead at the crossing 11. In the scenario above this would give a train 9 seconds of leeway for a decision. In practice, given the autonomy of the system, the decision time would be about 0.5 seconds.

Because the time before a potential accident is so critical we remain true to our ideals of autonomy for both train and crossing, but we also include this possibility of communication between crossing, train and the central office. It is not strictly necessary that this communication be done in 3D—here the function of any pair of matched cameras is to judge (accurately) distance, velocity and acceleration, to estimate the likelihood of collisions, to communicate this instantly, and all this specifically for safety. However 3D viewing is available, and the driver's view and the crossing's view may be seen in real-time in 3D in Centralized Train Control and elsewhere. Some note of the method follows.

FIG. 11 shows the processing for each camera pair. In this figure cameras 1 and 2 on a train 10 look down the tracks 12 as a driver's extra pair of eyes. This figure could as easily represent cameras pairs 3 and 4, and also 5 and 6 at a level crossing. The camera outputs are combined in a 3D video preprocessor 81, in which frames are tagged with location information 82 from the train's track sensors. (This could also be GPS coordinates but in general they will slower and less accurate. In tunnels they will not exist). This output is fed into a processor 83 which has internal DSP functions to create enhanced image stabilization, dual stream H.264 encoding, MJPEG encoding, an RS-485/RS-232 output to local storage 84, also an HDMI output (for local 3D viewing on heads-up display 85), and an output to a Physical Layer chip 86 for transmission over the Internet 87 (for remote 3D viewing at Centralized Traffic Control).

The processor 83 also has an output to a wireless connection using 802.11n for 4G communication speeds. From the Internet 87 there is added an MPEG separating module 88 to break the data into left and right streams for viewing in a remote display 100.

The frame combiner 81 and the processor 83 have the capacity to capture 500 MegaPixels per second and process full 3DHD of 1080p60 to a local display 85. The rate at which scenes can unfold on remote display 100, or data delivered to the Centralized Traffic Control is limited only by the capabilities of the Internet.

In this description we are following MPEG-4, which is a collection of methods defining compression of audio and visual (AV) digital data beginning in 1998. It was at that time designated a standard for a group of audio and video coding formats and related technology agreed upon by the ISO/IEC Moving Picture Experts Group (MPEG) under the formal standard ISO/IEC 14496. In July 2008, the ATSC standards were amended to include H.264/MPEG-4 AVC compression and 1080p at 50, 59.94, and 60 frames per second (1080p50 and 1080p60)—the last of which is used here. These frame rates require H.264/AVC High Profile Level 4.2, while standard HDTV frame rates only require Level 4.0. Uses of MPEG-4 include compression of AV data for web (streaming media) and CD distribution voice (telephone, videophone) and broadcast television applications). We could equally use any other protocol (or combination of protocols) suitable for transferring high-speed data over airwaves or land-lines.

In FIG. 11 the output to display 100 can come from storage 84 on the train or from storage closer to the office. For crossings the storage would most likely be on the Internet or at the office.

In the event of fog and rain some compensation may be made for impaired visibility by using either infra-red cameras, or the infra-red portion of the spectrum in existing cameras. However in these conditions all trains, especially freight trains, should be using every available means of computing their trajectory, and travelling more cautiously. Radar may also be used in unstable weather but it cannot discriminate between objects as accurately as optics.

A benefit of this system is that, with timely activation, independently of an operator and without a relayed input from a central office, so much in rolling stock, goods, the environment and lives can be saved.

The same applies to level crossings, which can alert cars and pedestrians and shut themselves down faster than with existing means, autonomously.

While the invention has been described and illustrated generally as a method for recognizing and measuring distances to objects such as trains, trucks, trees, people, etc., in relation to rail safety, in fact to those skilled in the art, the techniques of this invention can be understood and used as means for creating and perfecting three-dimensional recognition, inspection, measurement and safety tools for various subjects throughout the electro-magnetic spectrum and beyond.

It may be understood in this invention that although specific terms are employed, they are used in a generic and descriptive sense and must not be construed as limiting. The scope of the invention is set out in the appended claims.

While the invention has been described and illustrated (in general) as a method for recognizing distant objects and calculating their trajectory relative to a reference within the visible spectrum, in fact to those skilled in the art, the techniques of this invention can be understood and used as means for creating and perfecting recognition and motion measurement tools for various objects throughout the electro-magnetic spectrum and beyond. It is immaterial whether the recognition and calculations means are moving relative to fixed objects or the objects are moving relative to those means. It may also be understood that although specific terms are employed, they are used in a generic and descriptive sense and must not be construed as limiting. The scope of the invention is set out in the appended claims.

I claim:

1. A passive method of calculating parameters of fixed or moving objects relative to a fixed or moving reference comprising the steps of:
a. deploying a plurality of detection means for said reference to observe said objects;
b. recognizing said objects individually or collectively as being of concern to said reference;
c. coordinating said plurality of detection means so that data in meaningful form is returned to a processor of said reference for computing the parameters of relative motion between said objects of concern individually or collectively and said reference;
d. computing with said processor of said reference parameters such as trajectory, velocity, acceleration or deceleration, and future position of said objects, relative to said reference.

2. The method as in claim 1 wherein said deployment of said detection means is in a generally a forward looking direction towards the anticipated position of said objects of concern.

3. The method as in claim 1 wherein the coordination of said detection means are steps of:
a. closely aligning said imaging devices by means of physical manipulation;
b. finely aligning said imaging devices by means of image matching software; and
c. enabling, if and as necessary, the visualization of images of said objects of concern in three dimensions, i.e. 3D.

4. The method as in claim 1 for said reference to recognize an individual object, or several objects, as:
a. stationary in a place where it or they may interfere with the motion of said reference; or
b. moving in such a manner as to be a potential hazard to said reference.

5. The method as in claim 1 wherein said reference may recognize said objects as people, trees, stalled vehicles, other trains or any other objects on or near the tracks.

6. The method as in claim 1 wherein said processor may compute said parameters of trajectory, velocity, acceleration or deceleration, and future position of said objects as being potentially hazardous to said reference.

7. The method as in claim 1 wherein the computations of said processor may cause it to activate defensive measures in a reference such as setting a train's brakes or closing down a level crossing.

8. A viewing system comprising:
a. a pair or more of coordinated viewing devices;
b. a means of processing information received from said viewing devices;
c. a means of deciding, within said processing means and based on information received, that action is necessary; and
d. a means of activating defensive measures when action is necessary

9. The system as in claim 7 wherein said viewing devices are pairs of cameras coordinated to work in 3D.

10. The system as in claim 7 wherein the separation of said coordinated viewing devices is such as to maximize the visual acuity of the system.

11. The system as in claim 7 wherein the separation of said coordinated viewing devices is generally in a horizontal plane to provide optimal viewing of said objects of concern.

12. The system as in claim 7 wherein another optimal viewing sense may be in the vertical plane in the case of a train.

13. The system as in claim 7 wherein viewing senses may be at multiple angles

14. The system as in claim 7 wherein said means of processing information may coordinate with a means of reading the tracks to determine a train's precise location.

15. The system as in claim 7 wherein the viewing, processing, deciding and activating on information received is autonomous for said reference.

16. The system as in claim 7 wherein said reference may communicate said viewing, processing, deciding and activating to said objects of concern or to a central office or elsewhere.

17. The system as in claim 7 wherein said information may be processed quickly and efficiently through use of fast algorithms.

18. The system as in claim 7 wherein said viewing, processing, deciding and activating can be accomplished in less than half a second.

19. The system as in claim 7 wherein said activation on a train can be accomplished independently of an operator and of a central office and many times faster, potentially saving rolling stock, goods, the environment and lives.

20. The system as in claim 7 wherein a crossing can shut itself down independently of slower or less accurate information from other systems.
